(19) United States
(12) Patent Application Publication
(10) Pub. No.: US 2009/0096181 A1
(43) Pub. Date: Apr. 16, 2009

(54) Jobsite cart for transporting tools

(75) Inventors: Steven Wynne Cole, JR., Lombard, IL (US); Amy Judith Blackwood Smith, Chicago, IL (US)

Correspondence Address: GREER, BURNS & CRAIN, LTD., Suite 2500, 300 South Wacker Drive, Chicago, IL, 60606, US

(73) Assignees: Credo Technology Corporation; Robert Bosch GmbH

(21) Appl. No.: 11/974,303

(22) Filed: Oct. 12, 2007

(51) Int. Cl. B62B 1/12

(52) U.S. Cl. 280/47.35; 280/47.34

(57) ABSTRACT

Embodiments of the invention comprise a jobsite cart for transporting tools and other materials that comprise a metal frame having at least two spaced apart side members that are interconnected by an upper bridge member and at least one lower bridge member, a pair of spaced apart rotatable wheels operatively connected to the frame configured to enable the cart to be rolled along a ground surface, a handle at the top of the frame, a container operatively connected to and located on a first side of the frame and having an open top and a chamber for receiving tools and other materials therein, a cooler located in at least a portion of the chamber, a radio operatively connected to the frame, and a foldable table operatively connected to the frame and located on a second side of the frame which is opposite the first side thereof.

### BACKGROUND OF THE INVENTION

The present invention generally relates to carts for transporting tools and other materials to a jobsite.

Construction workers as well as service and maintenance workers that work at a jobsite often have to transport tools between their vehicles and a jobsite on a daily basis. Since many workers and small contractors use their own tools and are careful that they not be lost or stolen, they must routinely transport them from their vehicle to a jobsite. At the end of their work at the jobsite, they have to take the tools back to their vehicle. This is often a daily routine for many construction workers.

Some workers use wheeled carts to carry their tools and materials back and forth and will often stack tool boxes on the cart instead of carrying them. A common practice for many such workers is to use five gallon buckets to carry their tools. It is also a common practice in recent times for workers to transport an audio device to the jobsite in addition to a cooler for packing their lunch and liquids for the day. Jobsite audio devices may include AM/FM radios as well as MP3 players, CD players and the like.

Since many jobsites do not have readily available electric power outlets, workers may often transport long extension cords for powering electrical tools, lights and other equipment, such as battery pack chargers, for example. All of this equipment as well as other materials that may be needed for the work being done may be required to be transported from a worker's vehicle to the area at the jobsite in which he is working.

Workers who operate as small independent contractors, or who know and work in more than one trade, may have five gallon buckets that are suited for particular types of work, albeit carpentry, drywall, electrical, painting or other types of work and they may have five gallon buckets that have the necessary tools for the work in which they are doing at a jobsite on any particular day. If they have various ones of such work related tool buckets, they can choose the one they need to transport from their vehicle to the jobsite location.

Workers generally welcome developments which will enable them to more easily transport tools and other materials from their vehicle to a jobsite, particularly if the developments help organize their planning and reduce the time required to transport these tools and materials.

### SUMMARY OF THE INVENTION

Embodiments of the invention comprise a jobsite cart for transporting tools and other materials that comprise a metal frame having at least two spaced apart side members that are interconnected by an upper bridge member and at least one lower bridge member, a pair of spaced apart rotatable wheels operatively connected to the frame configured to enable the cart to be rolled along a ground surface, a handle at the top of the frame, a container operatively connected to and located on a first side of the frame and having an open top and a chamber for receiving tools and other materials therein, a cooler located in at least a portion of the chamber, an audio unit operatively connected to the frame, and a foldable table operatively connected to the frame and located on a second side of the frame which is opposite the first side thereof.

### DESCRIPTION OF THE DRAWINGS

FIG. 1 is a front perspective view of a preferred embodiment of the cart of the present invention;

FIG. 2 is a left rear perspective view of the embodiment shown in FIG. 1, particularly illustrating the foldable table shown in a closed or stored position;

FIG. 3 is a right rear perspective of the preferred embodiment shown in FIGS. 1 and 2, but illustrating the foldable table in its open position; and

FIG. 4 is a right side view of the embodiment shown in FIGS. 1-3, but illustrating the container without a tool skirt and the cart without an extension cord.

### DETAILED DESCRIPTION OF THE PREFERRED EMBODIMENTS

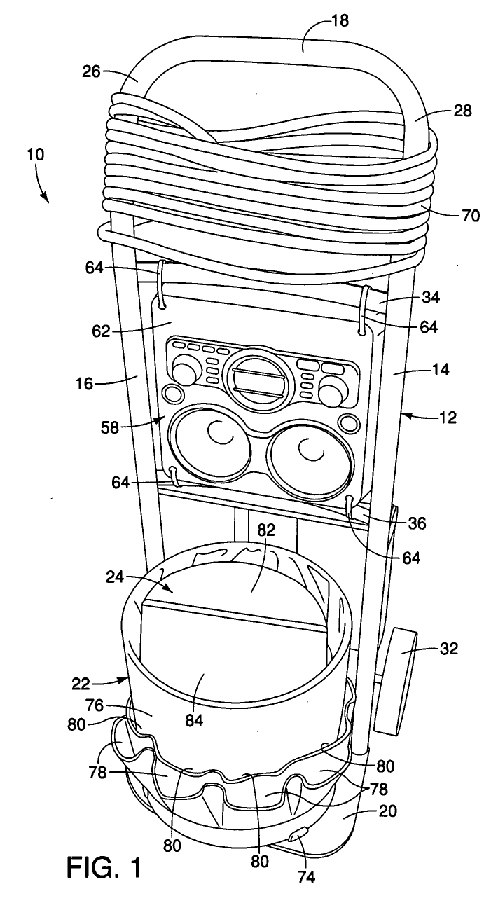

Embodiments of the jobsite cart for transport tools and other materials are shown and described herein in connection with FIGS. 1-4. The cart is indicated generally at 10 and includes a metal, preferably steel frame, indicated generally at 12, that has two side members 14 and 16 that merge with a top portion 18 to define a continuous handle. The side members extend to a generally horizontal flat bottom platform 20 that is configured to provide a support surface for a container, indicated generally at 22, that is configured to hold tools as well as a cooler, indicated generally at 24, if desired.

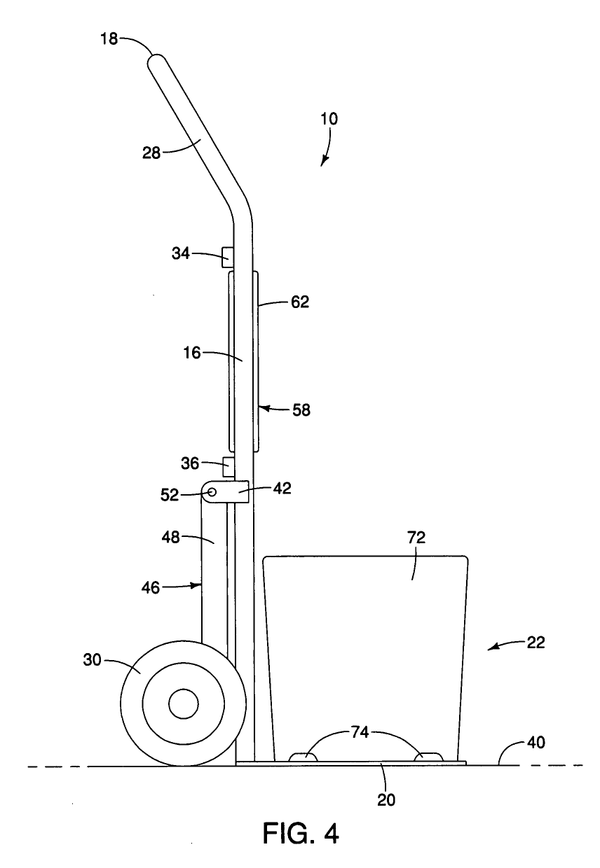

The frame 12 is preferably made of steel and the side members 14, 16 and the top handle member 18 are shown and preferably made of a single steel tubular structure that is continuous in its construction. The upper end 26 and 28 of the side members 14 and 16 are preferably slanted rearwardly as best shown in FIG. 4 as is typical for similar hand truck structures, inasmuch as it provides more convenient leverage for tipping the cart to balance it during transporting movement.

The cart 10 has a pair of spaced apart wheels 30 and 32 that rotate on an axle 34 that is mounted on a frame portion slightly rearwardly of the side members 14 and 16 and slightly elevated so that the bottom of the wheels is generally co-extensive with the bottom of the platform 20. While the platform may be bolted to the side members 14 and 16, they are preferably welded together. The side members 14, 16 are also braced intermediate the bottom and top portions by cross braces 34 and 36. These cross braces are preferably welded to the side members 14 and 16, although they too may be bolted or otherwise attached to the side members.

While the platform 20 is shown to have its bottom surface in contact with a ground surface 40, the cart may be constructed in a manner whereby the platform is elevated relative to the ground surface 40, in which case the wheels may be placed lower on the side members 14 and 16 and a downward extension provided on the outer front part of the platform 20 so that the extension and wheels will support the cart in the same orientation as is shown in FIG. 4 wherein the platform 20 is generally horizontal and the side members 14 and 16 are generally vertical.

The frame 12 also has plates 42 and 44 attached to side members 16 and 14 for supporting a foldable table, indicated generally at 46. The plates are preferably welded to the side member, but may be otherwise attached by bolts or the like. The foldable table 46 includes a top portion 48 and a leg portion 50, with the top portion being pivotally connected to the plates 42 and 44 by a rod 52.

It should be understood that while a long rod 52 that extends from one plate 42 to the other 44 may be used, it is also possible to use individual short bolts that connect the respective plates 42 and 44 to each side of the top portion 48. The leg portion 50 is also preferably pivotally mounted to the top portion by a long rod 54; however, it should be appreciated that individual bolts through the sides may be used if desired.

While the leg portion 50 is shown to have a center recess 56, it should be understood that other configurations may be used including a larger or smaller recess 56. Alternatively, the plate portion 50 may not extend substantially the entire width of the top portion 48, but may be configured to be a single leg having a narrow width and located in the center of the top portion 48. In other words, it may be approximately the width of the recess 56. While the table 46 is described as such, it is preferable that it be constructed so that if it has substantial strength so that it can hold relatively heavy objects, and in fact is preferably strong enough so that a worker may use it as a seat if desired.

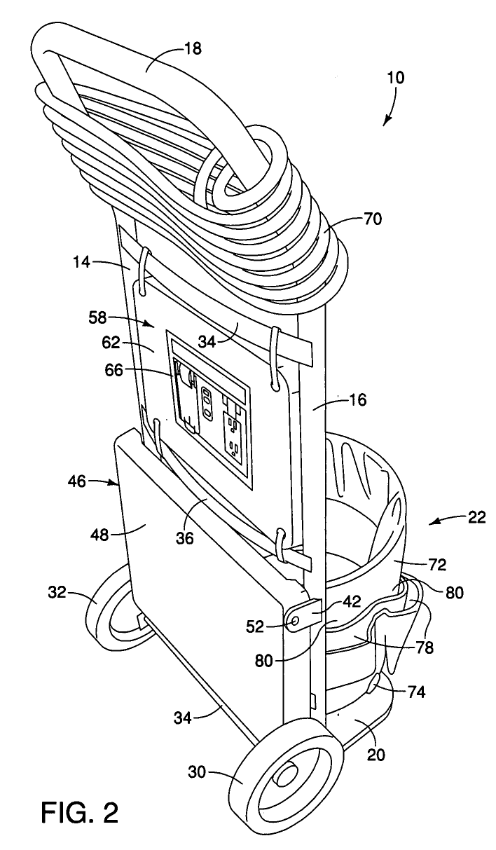

When the top portion 48 is in its stored position as shown in FIG. 2, the leg portion 56 folds into the top portion 48. It should be understood that while the leg and top portions 48 and 50 are shown to have a thickness of an inch or more, with the top portion 48 being thicker, both are preferably not solid structures, but are honeycombed or otherwise provided with transverse ribs or other strength imparting structure that is not extraordinarily heavy. The structure of these top and leg portions 48 and 50 must be compatible with the functional capability of the two portions folding together when in a closed or stored position as shown in FIGS. 2 and 4.

The cart 10 may also have an audio unit, indicated generally at 58, which preferably comprises a radio with a control panel having volume control, tuning control and a display. It may be configured to be MP3, CD or tape player and has speakers that are shown to direct the sound forwardly of the cart 10. The specific functionality of the audio unit 58 can very considerably as desired.

It is preferably contained in a relatively thin housing 62 that has a generally square configuration so that it can fit within the side members 14 and 16 as well as the cross braces 34 and 36. As shown, it is attached to the cross braces by conventional tie wraps 64 located at the upper and lower outer corners to hold the audio unit 58. The cross braces and side members provide a measure of protection against inadvertent damage that may be occasioned during use. It may be desirable to have the audio unit 58 be removable from the cart 10 and in such event, different kinds of releasable clips may be used rather than the tie wraps or other attachment means. Similarly, the housing 62 may be configured and sized to have openings or flanges that would enable it to be directly connected to the side members or to the cross braces or both.

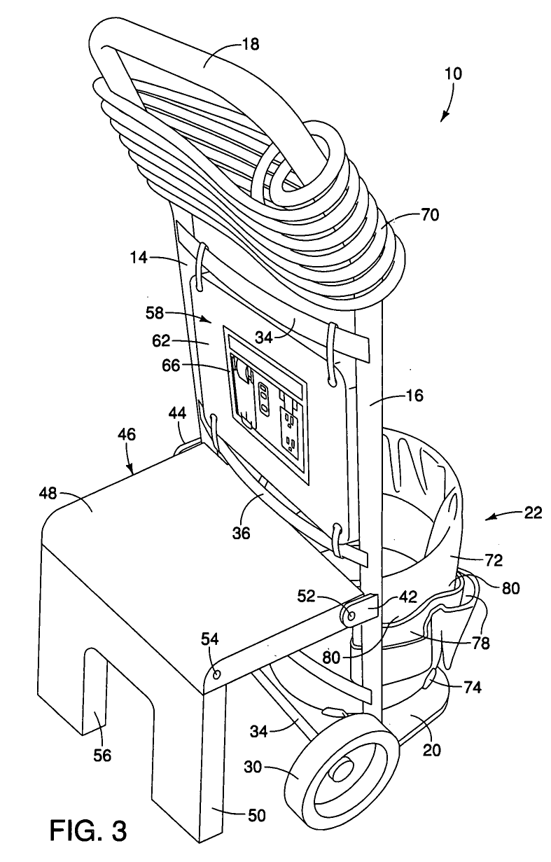

As shown in FIGS. 2 and 3, the housing 62 also has a pair of duplex AC outlets provided in the rear of the audio unit housing. While they may be standard duplex receptacles, it is preferred that they be fault circuit interrupters to provide an extra measure of safety for the users. If they are the latter, reset and test buttons are also preferably provided as is typical for such interrupters. An extension cord 70 may be provided and is shown to be wrapped around the upper portions 26 and 28 of the side members 14 and 16. While not shown, the extension cord 70 may conveniently be connected to a connector in the housing 62 so that power from a source of AC power may be interconnected with the ground fault circuit interrupters 66.

The container 22 is shown to be configured in size and shape as a conventional five gallon bucket 72 and rests upon the platform 20 as best shown in FIG. 4. The platform may have raised edges 74 as shown in FIG. 4 which restrain the container 22 from slipping off the platform during transporting. Alternatively, the raised edge could be generally continuous as desired.

The container 22 preferably has a skirt 76 that has at least one row of open topped compartments 78 for receiving and storing individual tools such as pliers, wire cutters, screwdrivers and the like and may have a second row of compartments 80 as shown if desired. The cooler 24 is shown to have a semi-cylindrical shape, but could be other shapes and configurations. The semi-cylindrical cooler 24 may have a removable top 82 and insulating side walls 84. By having a semi-cylindrical shape sized as shown, approximately half of the interior of the container 72 is available for storing tools and other materials.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the following claims.

What is claimed is:

1. A jobsite cart for transporting tools and other materials, comprising:
a metal frame having at least two spaced apart side members that are interconnected by an upper bridge member and at least one lower bridge member;
a pair of spaced apart rotatable wheels operatively connected to said frame configured to enable said cart to be rolled along a ground surface;
a handle at the top of said frame;
a container operatively connected to and located on a first side of said frame and having an open top and a chamber for receiving tools and other materials therein;
a radio operatively connected to said frame; and
a foldable table operatively connected to said frame and located on a second side of said frame which is opposite said first side thereof.

2. A jobsite cart as defined in claim 1 wherein said two spaced apart side members and said upper bridge member are a single integrally formed tubular steel structure, said upper bridge member defining said handle.

3. A jobsite cart as defined in claim 2 further comprising at least one reinforcing cross member attached to said side members intermediate said upper and lower bridge members.

4. A jobsite cart as defined in claim 1 wherein said frame further comprises a platform and at least one downward extension attached thereto that is configured to support said cart so that said platform is generally horizontally oriented and said side members are generally vertically oriented when said cart is resting on said wheels and said at least one extension.

5. A jobsite cart as defined in claim 4 wherein said container is located on and is supported by said platform.

6. A jobsite cart as defined in claim 1 further comprising a skirt carried by said container, said skirt having a plurality of open topped compartments extending around at least a substantial portion of the periphery of said skirt.

7. A jobsite cart as defined in claim 6 wherein said container is in the shape of a generally cylindrical bucket, said skirt extending around substantially the entire circumference of said bucket and having at least one row of compartments configured to receive and retain tools in said compartments.

8. A jobsite cart as defined in claim 1 wherein said radio has a relatively thin configuration and is secured to said frame between said side members.

9. A jobsite cart as defined in claim 7 further comprising a cooler located in at least a portion of said chamber, wherein said cooler has an outer generally semi-cylindrical shaped housing with an interior compartment and a top cover portion that provides access to said compartment, said housing being fabricated of an insulating material.

10. A jobsite cart as defined in claim 1 further comprising at least one GFCI outlet and an extension cord.

11. A jobsite cart as defined in claim 1 wherein said table has a generally flat top portion having a first end that is pivotally connected to said frame and a leg portion pivotally connected to a second end, said table being foldable from a closed position wherein said top and leg portions are generally parallel to said frame side members to an open position wherein said top portion is generally horizontal and said leg portion is generally perpendicular to said top portion.

12. A jobsite cart as defined in claim 11 wherein said table is designed and configured to withstand considerable weight and function as a seat for a user.

13. A jobsite cart as defined in claim 11 wherein said first end extends between and is connected to said side members.

14. A jobsite cart as defined in claim 10 wherein said radio has a housing with a generally narrow thickness and is attached to said frame between said handle and said collapsible table.

15. A jobsite cart as defined in claim 14 wherein said at least one GFCI outlet is provided in said radio housing.

16. A jobsite cart as defined in claim 1 wherein said radio is removably attached to said frame.

17. A jobsite cart for transporting tools and other materials, comprising:
a metal frame having at least two spaced apart side members that merge to define a continuous handle at the upper end and a front platform at the lower end thereof;
a pair of spaced apart rotatable wheels operatively connected to said frame configured to enable said cart to be rolled along a ground surface;
a container generally in the shape and size of a 5 gallon bucket supported by said platform for receiving tools and other materials therein;
a radio operatively connected to said frame; and
a foldable structure operatively connected to said frame and located on a rear side of said frame, structure being designed and configured to function as a seat or a table when in an open position and be foldable to be generally parallel to said side members when in a closed position.

18. A jobsite cart as defined in claim 17 wherein said side members and continuous handle are formed from tubular steel.

19. A jobsite cart as defined in claim 17 wherein said platform is configured to contact a ground surface and together with said wheels, hold said cart in a generally vertical position.

20. A jobsite cart as defined in claim 17 further comprising a skirt carried by said container, said skirt having a plurality of open topped compartments extending around at least a substantial portion of the periphery of said skirt for use in storing tools and other materials.

21. A jobsite cart as defined in claim 17 further comprising a cooler located in at least a portion of said chamber.
